(19) United States
(12) Patent Application Publication
(10) Pub. No.: US 2009/0046369 A1
(43) Pub. Date: Feb. 19, 2009

(54) EYECUP

(76) Inventor: Yasuyuki Aikawa, Kanagawa-ken (JP)

Correspondence Address: MILES & STOCKBRIDGE PC, 1751 PINNACLE DRIVE, SUITE 500, MCLEAN, VA, 22102-3833, US

(21) Appl. No.: 12/088,079

(22) PCT Filed: Oct. 4, 2006
(86) PCT No.: PCT/JP2006/320237

§ 371 Date: Mar. 25, 2008

(30) Foreign Application Priority Data
Oct. 7, 2005 (JP) 2005-294334

(51) Int. Cl. G02B 23/16

(52) U.S. Cl. 359/600

(57) ABSTRACT

An object of the present invention is to provide an eyecup such as a horn-shaped eyecup and the like capable to easily attach to a standard eyecup. The eyecup includes an intermediate member 3 that is removably attached to a standard eyecup 9 attached to an eyepiece portion 72 of a pair of binoculars; and an eyecup body 5 removably attached to the intermediate member 3.

### TECHNICAL FIELD

The present invention relates to an eyecup for a pair of binoculars, a telescope, and an optical instrument, and in particular to an eyecup easy to put on and take off.

### BACKGROUND ART

Generally, an eyecup is equipped with an eyepiece portion of an optical instrument as standard equipment such as a pair of binoculars and the like. The eyecup equipped as standard equipment (hereinafter called a standard eyecup) has a substantially cylindrical shape for preventing external light from entering and for making it easy to hold a distance between an eyepiece and a pupil constant. In a standard eyecup, there are a foldable type standard eyecup and a twist-up type standard eyecup. The standard eyecup has a construction capable of holding a distance between an eyepiece and a pupil constant for a user of an optical instrument whether the user is an eyeglass wearer or a non-eyeglass wearer.

The foldable type eyecup is usually made from deformable, soft rubber. The foldable type eyecup is equipped with a connecting portion for connecting to the eyepiece portion, and a protruding portion that protrudes from the connecting portion to a user side and is foldable toward the connecting portion. An annular groove is formed on an inner surface of the connecting portion, so that by fitting a flange formed on an outer surface of the eyepiece portion into the annular groove, the foldable type eyecup can be connected to the eyepiece portion. A non-eyeglass wearer protrudes the protruding portion toward the user, and an eyeglass wearer folds the protruding portion toward the connecting portion.

The twist-up type eyecup is connected to a twist-up ring of a twist-up mechanism formed on the eyepiece portion. When the twist-up ring is turned around an optical axis of the eyepiece, the twist-up ring moves toward the user along the optical axis, so that the eyecup becomes in a twisted-up state. The state corresponds to a non-eyeglass wearer. When the twist-up ring is turned in the reverse direction around the optical axis, the twist-up ring is moved toward the optical instrument side along the optical axis, so that the eyecup becomes in a twisted-in state. This state corresponds to an eyeglass wearer.

The twist-up type eyecup is usually firmly fixed on the twist-up ring by means of an adhesive and the like in order to prevent the eyecup from shifting in the circumferential direction or in the direction of the optical axis with respect to the twist-up ring.

In addition to the foldable type and the twist-up type standard eyecups, there are option eyecups. In the option eyecups, there is, for example, a horn-shaped eyecup for a non-eyeglass wearer.

A conventional horn-shaped eyecup is made from deformable, soft rubber, and is equipped with a connecting portion for connecting the eyepiece portion, and a protruding portion that protrudes from the connecting portion toward a user side and covers around an eye of the user (see “Nikon combined catalogue for binoculars”, issued on Nov. 4, 2004, page 23). An annular groove is formed on the inner surface of the connecting portion.

When a conventional horn-shaped eyecup is to be connected to an eyepiece portion of an optical instrument, at first, the connection between an annular groove of a connecting portion of a foldable type standard eyecup and a flange of the eyepiece portion is released, and the foldable type standard eyecup is removed.

Then, an annular groove of a connecting portion of the horn-shaped eyecup is connected to the flange of the eyepiece portion to fit the horn-shaped eyecup on the eyepiece portion.

On the other hand, since the twist-up type standard eyecup cannot be removed from the eyepiece portion, the twist-up type standard eyecup cannot be changed with the horn-shaped eyecup.

As described above, when a standard eyecup is a foldable type, the horn-shaped eyecup cannot be connected to the eyepiece portion unless the standard eyecup has been removed from the eyepiece portion, and the work to remove the eyecup is troublesome.

Moreover, when the standard eyecup is a twist-up type, since the eyecup cannot be removed from the eyepiece portion, the horn-shaped eyecup cannot be connected to the eyepiece portion.

### DISCLOSURE OF THE INVENTION

The present invention has been made in view of the above-described circumstances and has as an object to provide an eyecup such as a horn-shaped eyecup and the like capable of easily attaching to a standard eyecup.

In order to solve the problems, a first aspect of the present invention provides an eyecup including an intermediate member that is removably attached to a standard eyecup attached to an eyepiece portion of an optical instrument, and an eyecup body removably attached to the intermediate member.

In the first aspect of the present invention, it is preferable that the intermediate member includes a cylindrical body that has a cylindrical shape and formed by an elastic material, and a notch that is formed on the cylindrical body and makes a diameter of the cylindrical body expandable.

In the first aspect of the present invention, it is preferable that the eyecup body has an annular body formed by an elastic material, and a horn portion that is formed at an opening side of the annular body, and that a protruding portion is formed on one of an outer surface of the cylindrical body and an inner surface of the annular body, and a concavity portion capable of fitting to the protruding portion is formed on the other.

In the first aspect of the present invention, it is preferable that the inner surface of the cylindrical body has a tapered shape.

According to a second aspect of the present invention, there is provided an intermediate member that is removably attached on an outer surface a standard eyecup installed in an eyepiece portion of an optical instrument, and lies between the standard eyecup and another eyecup.

The present invention makes it possible to easily attach an eyecup such as a horn-shaped eyecup and the like to a standard eyecup.

### BRIEF DESCRIPTION OF THE DRAWINGS

FIG. 1 is a partial sectional view showing a state that a horn-shaped eyecup according to a first embodiment of the present invention is connected to a standard eyecup.

FIG. 2 a perspective view of an intermediate member of the horn-shaped eyecup shown in FIG. 1.

FIG. 3 is a sectional view of an eyecup body of the horn-shaped eyecup shown in FIG. 1.

FIG. 4 is a sectional view showing another state upon attaching the horn-shaped eyecup shown in FIG. 1 on a standard eyecup.

FIG. 5 is a sectional view showing a state upon attaching the horn-shaped eyecup shown in FIG. 1 on a foldable type standard eyecup.

### THE BEST MODE FOR CARRYING OUT THE INVENTION

An embodiment according to the present invention is explained below with reference to accompanying drawings.

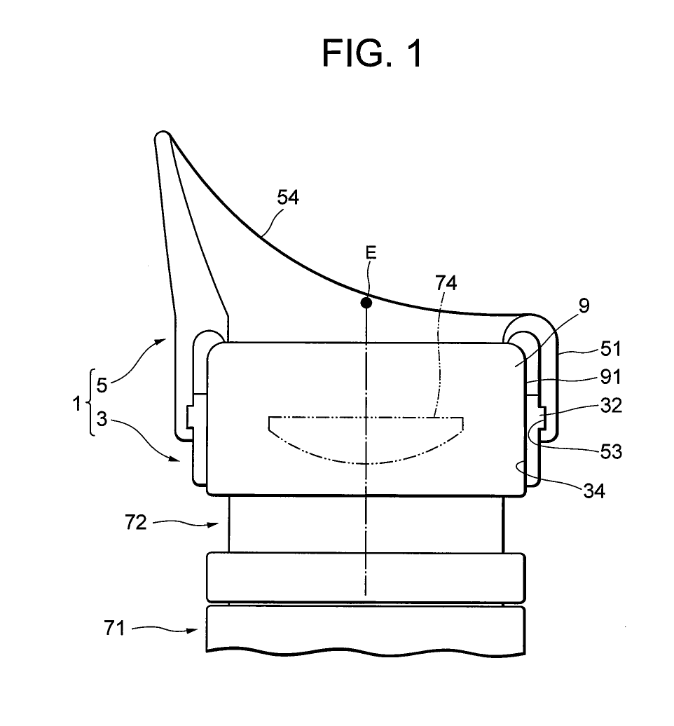

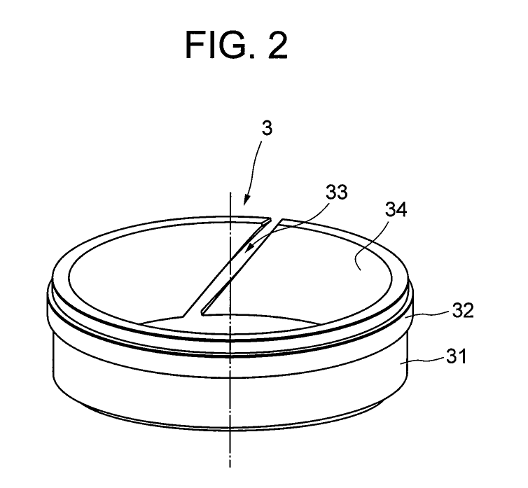

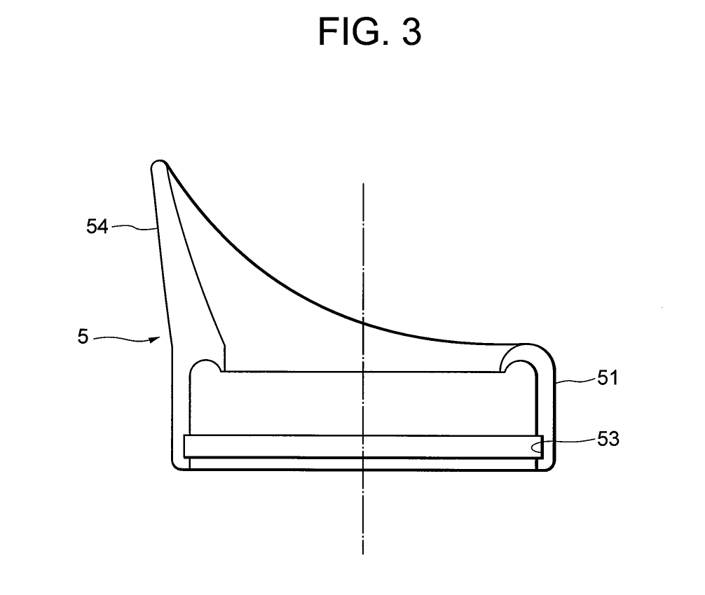

FIG. 1 is a partial sectional view showing a state that a horn-shaped eyecup according to a first embodiment of the present invention is connected to a standard eyecup. FIG. 2 a perspective view of an intermediate member of the horn-shaped eyecup shown in FIG. 1. FIG. 3 is a sectional view of an eyecup body of the horn-shaped eyecup shown in FIG. 1.

As shown in FIG. 1, a horn-shaped eyecup (an eyecup) 1 is attached to a twist-up type standard eyecup 9 connected to an eyepiece portion 72 of a pair of binoculars. The horn-shaped eyecup 1 is equipped with an intermediate member 3 and an eyecup body 5. The horn-shaped eyecup 1 is for non-eyeglass wearers.

As shown in FIG. 2, the intermediate member 3 has a cylindrical body 31 with a substantially cylindrical shape. An annular protruding portion 32 is formed on an outer surface of the cylindrical body 31. The protruding portion 32 is located to an opening side of the cylindrical body 31. The intermediate member 3 is made from plastic with elasticity such as polycarbonate. A notch 33 is formed on the cylindrical body 31 and the protruding portion 32. The notch 33 extends from one opening to the other of the cylindrical body 31. The notch 33 diagonally crosses the circumferential direction of the cylindrical body 31. With the notch 33, the diameter of the cylindrical body 31 can be expanded. The inner surface of the intermediate member 3 is a tapered surface 34. In this embodiment, although the inner surface of the intermediate member 3 is a tapered shape, the inner surface is not necessary to be a tapered shape. The tapered surface 34 is closely adhered to a tapered surface 91 formed on the outer surface of the standard eyecup 9. A tip side portion of the tapered surface 91 is narrower than a bottom side portion (a binocular body 71 side portion) of the tapered surface 91 (see FIG. 1). The inner diameter of the intermediate member 3 under normal conditions (not elastically deformed condition) is a little smaller than the outer diameter of the standard eyecup 9. As for the material of the intermediate member 3, in addition to polycarbonate, acrylonitrile-butadiene-styrene (ABS) resin, epoxy resin, urethane resin, aluminum, and stainless steel are preferably used. It is necessary that the material of the intermediate member 3 should be different from the material used for forming the eyecup body. This is because after attaching the intermediate member to the eyecup body, the attached position can be changeable. When the material of the intermediate member and that of the eyecup body are the same, it becomes difficult to change attached position after attaching because of friction between the eyecup body and the intermediate member. In particular, upon using soft rubber (such as silicone rubber) for the eyecup body, when the same materials make contact with each other, it becomes extremely difficult to change attached position because of friction. Accordingly, the material for the intermediate member does not use soft rubber (such as silicone rubber, and NBR).

As shown in FIG. 3, the eyecup body 5 has an annular body 51 and a horn portion 54. The eyecup body 5 is made from soft rubber material (such as silicone rubber, and NBR (acrylonitrile butadiene rubber)). The horn portion 54 is formed at one opening end of the annular body 51 in a body. An annular groove (concavity portion) 53 is formed on the inner surface of the annular body 51. The groove 53 is located to the other opening end of the annular body 51. The horn portion 54 has a shape closely fitting around an eye of a user. The horn portion 54 is made from soft rubber material (such as silicone rubber, and NBR (acrylonitrile butadiene rubber)). This is the same material as a conventional horn-shaped eyecup.

In order to attach the horn-shaped eyecup 1 according to the first embodiment to a standard eyecup, at first, the intermediate member 3 is separated from the eyecup body 5 in advance.

Then, the diameter of the intermediate member 3 is expanded by your finger.

With this state, the intermediate member 3 is positioned to the binocular body 71 side of the standard eyecup 9 as shown in FIG. 1, and remove your finger from the intermediate member 3. As a result, the intermediate member 3 varies from a state spreading toward outer radius direction to a state closing toward inner radius direction (a state before attaching to the standard eyecup 9), and the intermediate member 3 is fixed to the standard eyecup 9 by elasticity of the cylindrical body 31.

Then, a portion of the groove 53 of the eyecup body 5 is fitted to the protruding portion 32 of the intermediate member 3.

Then, with pulling the annular body 51 of the eyecup body 5, the other portions of the groove are fitted to the protruding portion 32. When the entire groove 53 has completely been fitted to the protruding portion 32, the attaching operation of the horn-shaped eyecup is completed.

Upon using the horn-shaped eyecup 1, with a state of naked eye, a user places the circumference of his/her eye on the horn-shaped eyecup 1, and imposes lightly on the horn portion 54. As a result, the horn portion 54 elastically deforms in accordance with the shape of the circumference of the eye, and makes close contact with the circumference of the eye, so that external light does not leak into the horn-shaped eyecup 1. Moreover, a positional relation between an eyepoint E of the eyepiece 74 and a pupil (not shown) of the user of the binoculars can substantially be kept constant by the horn-shaped eyecup 1.

As described above, according to the embodiment, it becomes possible to attach a horn-shaped eyecup 1, which has been impossible to attach, to a twist-up type standard eyecup 9.

Moreover, since the notch 33 is diagonally crossed the circumferential direction of the intermediate member 3, upon expanding the diameter of the intermediate member 3 variation in the width of the notch 33 is not conspicuous with respect to a case where the notch is perpendicular to the circumferential direction of the intermediate member, so that the external appearance is not spoiled.

In the embodiment, although the protruding portion 32 is an annular shape, the protruding portion 32 is not necessary to be annular, it may be, for example, a cylindrical shape, a hemisphere, or the like. In this case, the concavity portion may be a circular hole and the like instead of the groove 53.

In the embodiment, although the protruding portion 32 is formed on the intermediate member 3, and as for the concavity portion, the groove 53 is formed on the eyecup body 5, the protruding portion may be formed on the eyecup body, and the concavity portion may be formed on the intermediate member.

Moreover, in the embodiment, although the diameter of the intermediate member 3 is expanded by the notch 33, the configuration to expand the diameter is not limited to this. For example, a plurality of slits may be formed at a given distance along the circumferential direction of the cylindrical body 31 of the intermediate member 3. In this case, an end of the slit is located at an end of an opening, and the other end of the slit does not reach the end of the other opening.

In the embodiment, although the slot 33 is a slit with a given width, it is not necessary to be a slit, and it may be a cutting without a gap.

In the embodiment, although the slot 33 is formed such that the slot 33 is diagonally crosses the circumferential direction of the cylindrical body 31, it is not necessary to form the slot 33 such a manner, the slot 33 may be formed, for example, perpendicularly to the circumferential direction of the cylindrical body 31.

In the embodiment, although the eyecup is a horn-shaped eyecup 1, the scope of the present invention is not limited to the horn-shaped eyecup 1. It can be applied to, for example, an eyecup having different diameter from the standard eyecup 9.

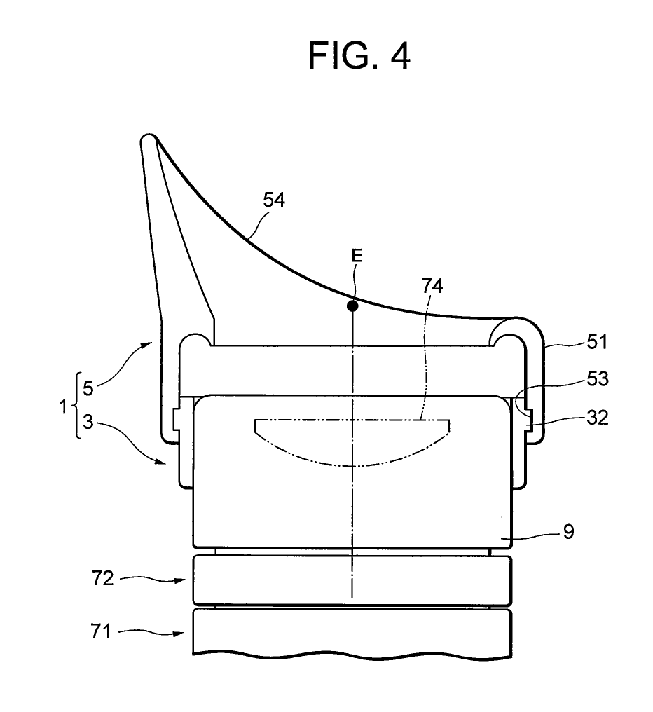

FIG. 4 is a sectional view showing another state upon attaching the horn-shaped eyecup shown in FIG. 1 on a standard eyecup.

The horn-shaped eyecup shown in FIG. 4 is the same one shown in FIG. 1. The horn-shaped eyecup shown in FIG. 4 differs from the one shown in FIG. 1 only in the way to attach to the standard eyecup 9.

Although the horn-shaped eyecup 1 shown in FIG. 1 is attached to a standard eyecup 9 which is in a twist-up state (a state for a non-glasses wearer), the one shown in FIG. 4 is attached to a standard eyecup 9 which is in a twist-in state (a state for a glasses wearer).

In the state upon attaching the horn-shaped eyecup 1 shown in FIG. 4, in order to make the positional relation between the eyepoint E and a pupil (not shown) of the binoculars user same as that of FIG. 1, the intermediate member 3 is positioned to a side opposite to the binocular main body 71 side of the standard eyecup 9 and fixed.

As described above, the horn-shaped eyecup 1 can be attached to the standard eyecup 9 either in the twist-up state or in the twist-in state.

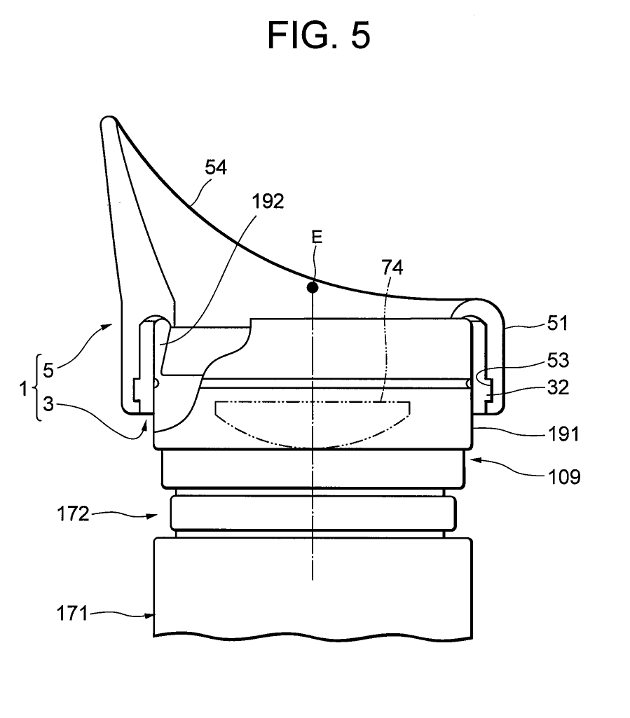

FIG. 5 is a sectional view showing a state upon attaching the horn-shaped eyecup shown in FIG. 1 on a foldable type standard eyecup.

The horn-shaped eyecup 1 shown in FIG. 5 is the same one shown in FIG. 1. As shown in FIG. 5, the horn-shaped eyecup 1 can be attached to a foldable type standard eyecup 109.

In order to attach the horn-shaped eyecup 1 to the foldable type standard eyecup 109, a folding portion 192 of the standard eyecup 109 is extended without folding in advance. Moreover, the intermediate member 3 is removed from the eyecup body in advance.

Then, the diameter of the intermediate member 3 is expanded by your finger.

With this state, the intermediate member 3 is positioned to the side opposite to the binocular body 171 side of the standard eyecup 109 as shown in FIG. 5, and remove your finger from the intermediate member 3. In this case, the protruding portion 32 of the intermediate member 9 [sic] is made to come closer to the binoculars body 171. This is because the tip portion of the tapered surface 191 of the foldable standard eyecup 109 is thicker than the base portion (the binoculars body 171 side), which is the opposite case of the tapered surface 91 of the twist-up standard eyecup 9.

The intermediate member 3 is fixed to the standard eyecup 109 by elasticity of the cylindrical body 31.

Then, when the groove 53 of the eyecup body 5 is fitted to the protruding portion 32 of the intermediate member 3 similar to the fitting procedures upon attaching the horn-shaped eyecup 1 to the twist-up type standard eyecup 9, the fitting works of the horn-shaped eyecup 1 has been completed.

As described above, the horn-shaped eyecup 1 can be easily attached not only to the twist-up type standard eyecup 9 but also to the foldable standard eyecup 109.

Moreover, since the conventional work to remove the foldable standard eyecup 109 from the eyepiece portion 172 has no longer been necessary, the horn-shaped eyecup 1 can be easily attached to the eyepiece portion 172.

Furthermore, since the standard eyecup 109 is not removed from the eyepiece portion 172, it becomes possible to prevent the standard eyecup 109 from being lost.

In each embodiment, although the intermediate member 3 is situated as a component of the horn-shaped eyecup 1, the intermediate member 3 may be a component being independently traded. In this case, the horn-shaped eyecup 1 is composed only of the eyecup body 5.

1. An eyecup comprising:
an intermediate member that is removably attached to a standard eyecup attached to an eyepiece portion of an optical instrument; and
an eyecup body removably attached to the intermediate member.

2. The eyecup according to claim 1, wherein the intermediate member includes a cylindrical body that has a cylindrical shape and formed by an elastic material, and a notch that is formed on the cylindrical body and makes a diameter of the cylindrical body expandable.

3. The eyecup according to claim 2,
wherein the eyecup body has an annular body formed by an elastic material, and a horn portion that is formed at an opening side of the annular body, and
wherein a protruding portion is formed on one of an outer surface of the cylindrical body and an inner surface of the annular body, and a concavity portion capable of fitting to the protruding portion is formed on the other.

4. The eyecup according to claim 2, wherein the inner surface of the cylindrical body has a tapered shape.

5. An intermediate member that is removably attached on an outer surface of a standard eyecup installed in an eyepiece portion of an optical instrument, and lies between the standard eyecup and another eyecup.

6. The eyecup according to claim 3, wherein the inner surface of the cylindrical body has a tapered shape.
